(19) United States
(12) Patent Application Publication
(10) Pub. No.: US 2026/0172985 A1
(43) Pub. Date: Jun. 18, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: KAZUYUKI TOTA, Kanagawa (JP)

(21) Appl. No.: 19/462,822

(22) Filed: Jan. 28, 2026

Related U.S. Application Data
(63) Continuation of application No. PCT/JP2024/025873, filed on Jul. 19, 2024.

(30) Foreign Application Priority Data
Aug. 1, 2023 (JP) 2023-125726

(51) Int. Cl. H04W 52/24; H04W 72/0453

(52) U.S. Cl. CPC H04W 52/245; H04W 72/0453

(57) ABSTRACT

A communication apparatus determines, based at least on a received signal strength of a trigger frame, information indicating transmission power included in the trigger frame, and a frequency resource permitted to be used by the communication apparatus for uplink transmission which has been identified based on information regarding resource allocation included in the trigger frame, tones to be used for uplink communication in the frequency resource and an output signal strength of subcarrier signals in the tones, and transmits, at the determined output signal strength, a Trigger-based (TB) Physical layer Protocol Data Unit (PPDU) in which data is superimposed on subcarriers corresponding to the determined tones.

### CROSS-REFERENCE TO RELATED APPLICATIONS

This application is a Continuation of International Patent Application No. PCT/JP2024/025873, filed Jul. 19, 2024, which claims the benefit of Japanese Patent Application No. 2023-125726, filed Aug. 1, 2023, both of which are hereby incorporated by reference herein in their entirety.

### BACKGROUND

### Field of the Technology

The present disclosure relates to a communication apparatus that communicates data.

### Description of the Related Art

In recent years, with the increase in the amount of data being communicated, the development of communication technologies such as wireless Local Area Network (LAN) has progressed. As major communication standards for wireless LAN, the Institute of Electrical and Electronics Engineers (IEEE) 802.11 standard series is known. The IEEE 802.11 standard series includes standards such as IEEE 802.11a/b/g/n/ac/ax.

Japanese Patent Laid-Open No. 2018-050133 describes a technique of performing data communication using the Orthogonal frequency-division multiple access (OFDMA) technology in communication based on the IEEE 802.11 standard series. Specifically, a mechanism is disclosed in which, by using the OFDMA technology, an access point apparatus (hereinafter also referred to as an “AP”) simultaneously receives uplink data from a plurality of station apparatuses (hereinafter also referred to as “STA”s). This mechanism is hereinafter also referred to as the “Uplink OFDMA function.”

In the above-described Uplink OFDMA function, the AP simultaneously communicates with STAs that are located at individually different positions and in different radio environments. In view of this, each STA performs Power Pre-Correction control to adjust its transmission power in consideration of spatial propagation loss between the STA and the AP. When adjusting these transmission powers, or when controlling the transmission power for transmitting a normal Physical layer Protocol Data Unit (PPDU), it is necessary to perform power control so that the transmission power does not exceed the maximum transmission output power stipulated by the radio laws of each country.

Meanwhile, in order to transmit data to a more distant counterpart device, it is effective to increase the maximum transmission power. In the aforementioned Uplink OFDMA, the communication channel used for simultaneous communication is divided into finer frequency resources, and the finer frequency resources are each allocated to the corresponding STA to realize simultaneous communication. The unit of this division is called a Resource Unit (RU).

### SUMMARY

The maximum transmission output power of each STA in Uplink OFDMA must also satisfy the transmission power density regulations stipulated by the radio laws of each country. Therefore, there is an issue in that it is difficult for the AP to simultaneously receive data from both an STA that is far from the AP and an STA that is relatively close to the AP.

The present disclosure has been made in view of at least one of the above issues. One aspect of the present disclosure is directed to providing a mechanism that, by devising the manner of using Resource Units (RUs), enables the AP to receive data from an STA located far from the AP while satisfying the prescribed maximum transmission power density for the entire predetermined bandwidth.

According to an aspect of the present disclosure, a communication apparatus comprises a reception unit configured to perform a reception control to receive a trigger frame, a determination unit configured to determine, based at least on a received signal strength of the trigger frame received by the communication apparatus, information indicating transmission power included in the trigger frame, and a frequency resource permitted to be used by the communication apparatus for uplink transmission which has been identified based on information regarding resource allocation included in the trigger frame, tones to be used for uplink communication in the frequency resource and an output signal strength of subcarrier signals in the tones, a transmission control unit configured to perform a transmission control to transmit, at the determined output signal strength, a Trigger-based (TB) Physical layer Protocol Data Unit (PPDU) in which data is superimposed on subcarriers corresponding to the tones determined as tones to be used, wherein, in the determining, the tones to be used for uplink communication and the transmission output power are determined so that a transmission power density for the frequency resource as a whole is within a predetermined transmission power density specified for each predetermined frequency bandwidth, and in performing the transmission control, transmission is controlled so that subcarrier signals are not transmitted on other tones included in the frequency resource that are different from the tones to be used for uplink communication.

Features of the present disclosure will become apparent from the following description of embodiments with reference to the attached drawings.

### BRIEF DESCRIPTION OF THE DRAWINGS

FIG. 1 is a diagram illustrating an example of a configuration of a communication system.

FIG. 2 is a diagram illustrating an example of a hardware configuration of a communication apparatus, which is an access point (AP) or a station (STA).

FIG. 3 is a diagram illustrating an example of a functional configuration of a communication apparatus, which is an AP or an STA.

FIG. 4 is a schematic diagram illustrating an example of RU allocation in a 20 MHz channel.

FIG. 5 is a schematic diagram illustrating a format of a trigger frame.

FIG. 6A is a schematic diagram illustrating an example of a method of using tones according to a first embodiment. This is an example in which only one tone in a sub-Resource Unit (sRU) is used for communication.

FIG. 6B is a schematic diagram illustrating an example of a method of using tones according to the first embodiment. This is an example in which transmission power is controlled to compensate for power deficit.

FIG. 7 is a schematic diagram illustrating a comparative example of methods of using tones.

FIG. 8 is a flowchart illustrating an example of control executed by the STA according to the first embodiment.

FIG. 9A is a schematic diagram illustrating received power at the AP. This illustrates an example of reception when transmission power is not adjusted.

FIG. 9B is a schematic diagram illustrating received power at the AP. This illustrates an example in which the received power of signals received from each STA at the AP is made uniform.

FIG. 9C is a schematic diagram illustrating received power at the AP. This illustrates an example in which transmission is performed at the maximum transmission power when the transmission power to be used for transmission exceeds the maximum transmission output power.

FIG. 10 is a schematic diagram illustrating received power at the AP.

### DESCRIPTION OF THE EMBODIMENTS

Hereinafter, embodiments will be described in detail with reference to the attached drawings. It should be noted that the following embodiments are not intended to limit the disclosure according to the claims. Although a plurality of features is described in the embodiments, not all of these features are necessarily essential to the disclosure, and the plurality of features may be combined arbitrarily. Furthermore, in the attached drawings, the same reference numerals are assigned to the same or similar configurations, and redundant descriptions are omitted.

### First Embodiment

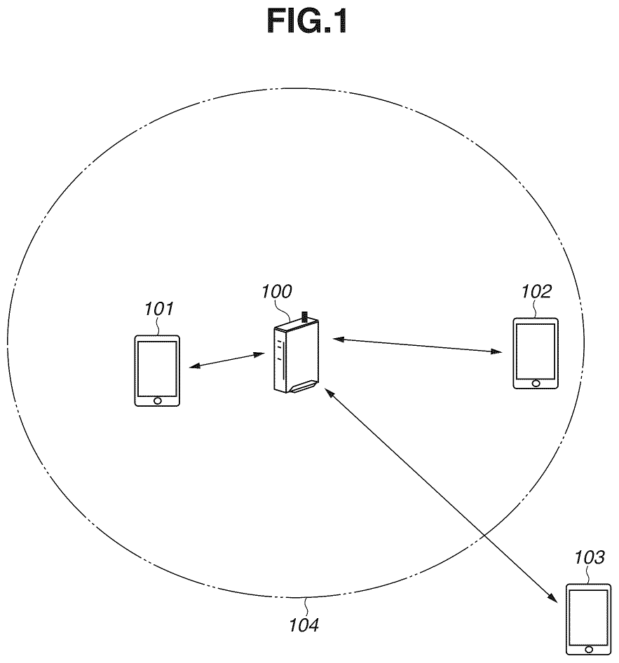

FIG. 1 illustrates an example configuration of a network according to the present embodiment. The network of the present embodiment includes one access point apparatus (hereinafter simply referred to as an “AP”, “AP STA”, or “access point”) and three station apparatuses (hereinafter simply referred to as a “STA”, “Non-AP STA”, or “station”).

An AP 100 and STAs 101 to 103 are capable of communicating wireless frames in compliance with the IEEE 802.11bn standard, which is a successor standard to the IEEE 802.11be standard, targeting a maximum transmission rate of 46.08 Gigabits per second (Gbps).

Note that IEEE stands for Institute of Electrical and Electronics Engineers. The IEEE 802.11bn standard, which is a successor to IEEE 802.11be, is characterized mainly by high-reliability communication, low-latency communication, and improved throughput during congestion. In addition, the 802.11bn standard also aims to reduce power consumption at the AP as one of its objectives. A wireless frame communicated according to this successor standard is also referred to as an Ultra High Reliability (UHR) Physical layer Protocol Data Unit (PPDU).

Note that the name UHR is provided for convenience in view of the objectives to be achieved by the successor standard and its key features, and the name may change once the standardization is completed. Similarly, the name IEEE 802.11bn may also change once the standardization is completed. On the other hand, it should be noted that the present specification and the attached claims are essentially applicable to all successor standards to the IEEE 802.11be standard.

The AP 100 and the STAs 101 to 103 can communicate in frequency bands such as the 2.4 GHz band, 5 GHz band, 6 GHz band, and millimeter-wave bands such as the 45 GHz band and 60 GHz band.

The frequency bands used by each communication apparatus are not limited to these, and a different frequency band such as the Sub-1 GHz band may also be used. In addition, the communication apparatuses 100 to 103 can communicate using bandwidths of 20 MHz, 40 MHz, 80 MHz, 160 MHz, 320 MHz, 540 MHz, 640 MHz, 1080 MHz, and 2160 MHz. The bandwidths used by each communication apparatus are not limited to these.

Furthermore, although the AP 100 and the STAs 101 to 103 are described as supporting communication (transmission and reception) of UHR PPDUs, the AP 100 and the STAs 101 to 103 may also be configured to support communication of legacy standard PPDUs, which are standards prior to the UHR standard. Specifically, the AP 100 and the STAs 101 to 103 may be configured to support transmission and reception of PPDUs according to standards such as IEEE 802.11a/b/g/n/ac/ax/be.

Furthermore, the AP 100 and the STAs 101 to 103 may also be configured to support wireless communication based on other communication standards such as Bluetooth®, Near Field Communication (NFC), and Bluetooth® Low Energy (LE). In addition, the AP 100 and the STAs 101 to 103 may be configured to support wired communication using Ethernet cables or optical fiber. Specific examples of the AP 100 include a wireless LAN router or a personal computer (PC), but are not limited thereto. The AP 100 and the STAs 101 to 103 may also be information processing apparatuses such as wireless chips that support transmission and reception of UHR PPDUs. In this case, various controls can be executed by hardware circuits inside the wireless chip. Furthermore, various processes may be executed by cooperation between processors such as application-specific instruction set processor (ASIP), memory, and hardware circuits inside the wireless chip.

Specific examples of the STAs 101 to 103 include cameras, tablets, smartphones, PCs, mobile phones, video cameras, and wearable devices such as smart glasses, but are not limited thereto. The STAs may also be Internet of Things (IoT) sensors, smart locks, smart sensors, or other IoT devices. The IoT sensors may be, for example, acceleration sensors, light sensors, or humidity sensors.

Returning to the description of FIG. 1, an area 104 indicates an area in which the AP 100 and the STAs 101 to 103 can communicate well. Communication between devices may be one-to-one communication, or Multi-User (MU) communication between the AP 100 and multiple STAs. The following provides a more detailed description of simultaneous communication relevant to the present embodiment.

Each communication apparatus illustrated in FIG. 1 can perform MU communication using the Orthogonal Frequency Division Multiple Access (OFDMA) technology. In addition, the communication apparatuses 100 to 103 can perform MU communication using the Multi-User Multi-Input Multi-Output (MU-MIMO) technology. Furthermore, MU communication using both the OFDMA technology and the MU-MIMO technology in combination can also be performed.

That is, a plurality of STAs among the AP 100 and the STAs 101 to 103 can communicate simultaneously on a single channel (including a channel with a channel width of 40 MHz or more that has been combined). In the OFDMA technology, a single channel is divided into a plurality of subchannels called Resource Units (RUS), and each RU is allocated to a different STA (or a group of STAs). By using the allocated RUs, the AP and a plurality of STAs can communicate simultaneously on a single channel, thereby realizing multiple access.

Hereinafter, in the present embodiment, the function in which the AP 100 simultaneously receives uplink data from a plurality of STAs is referred to as the Uplink OFDMA function.

In the above-described Uplink OFDMA function, the AP 100 simultaneously communicates with the STAs that are located at individually different positions and in different radio environments, as illustrated in FIG. 1. In view of this, each STA performs Power Pre-Correction control to adjust its transmission power in consideration of spatial propagation loss between the STA and the AP. When adjusting these transmission powers, or when controlling the transmission power for transmitting a normal PPDU, it is necessary to perform power control so that the transmission power does not exceed the maximum transmission output power stipulated by the radio laws of each country.

Meanwhile, in order to transmit data to a more distant counterpart device, it is effective to increase the maximum transmission power. In Uplink OFDMA, as described above, the communication channel used for simultaneous communication is divided into finer frequency resources and the fine frequency resources are each allocated to the corresponding STA to realize simultaneous communication.

The maximum transmission output power of each STA for such a case is also limited by the transmission power density stipulated by the radio laws of each country, and there may be cases where it becomes difficult for the AP to simultaneously receive data from both an STA that is far from the AP and an STA that is relatively close to the AP.

In view of this, the present embodiment provides a mechanism that, by devising the manner of using the RUs, enables the AP to receive data from an STA located far from the AP while satisfying the prescribed maximum transmission power density for the entire predetermined bandwidth. The details are described below.

### <Hardware Configuration of a Communication Apparatus>

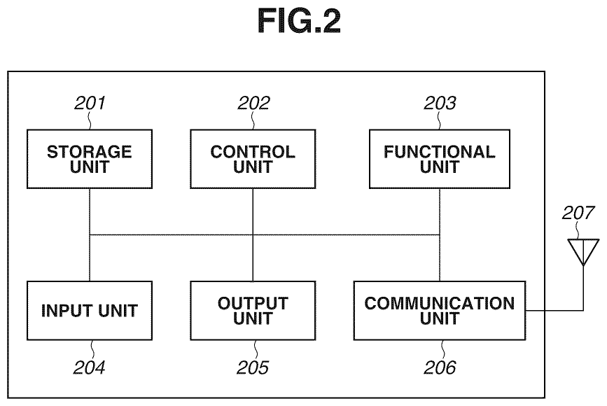

FIG. 2 illustrates an example of a hardware configuration of a communication apparatus (AP 100, STAs 101 to 103). As an example of the hardware configuration, the communication apparatus includes a storage unit 201, a control unit 202, a functional unit 203, an input unit 204, an output unit 205, a communication unit 206, and antennas 207 to 209.

The storage unit 201 is constituted by both a read-only memory (ROM) and a random access memory (RAM), or by either one, and stores programs for performing various operations described below, as well as various pieces of information such as communication parameters for wireless communication. In addition to the ROM and RAM, the storage unit 201 may use storage media such as non-volatile storage devices including a hard disk and a Solid State Drive (SSD).

The control unit 202 is constituted by, for example, a processor such as a central processing unit (CPU) or a micro processing unit (MPU), an Application-Specific Integrated Circuit (ASIC), a Digital Signal Processor (DSP), or a Field Programmable Gate Array (FPGA). The control unit 202 executes programs stored in the storage unit 201 and controls the entire apparatus by operating hardware circuits such as the ASICs. The control unit 202 may also control the entire apparatus in cooperation with an Operating System (OS) stored in the storage unit 201.

The control unit 202 also controls the functional unit 203 to execute predetermined processing such as imaging, printing, or projection. The functional unit 203 is hardware for the apparatus to execute predetermined processing in. For example, in a case where the communication apparatus is a camera such as a digital still camera or a smartphone with a camera, the functional unit 203 is an imaging unit, and performs imaging processing of surrounding images via a camera unit (not shown) included in the communication apparatus. In a case where the communication apparatus is a printer, the functional unit 203 is a printing unit, and performs printing processing on a sheet such as paper based on print data obtained from an external source via wireless communication. In a case where the communication apparatus is a projector or smart glasses, the functional unit 203 is a projection unit, and performs projection processing of image data or video data obtained from an external source via wireless communication. In the case of smart glasses, the projection surface is, for example, the retina of an end user. The data processed by the functional unit 203 may be data stored in the storage unit 201, or data communicated with another AP or STA via the communication unit 206 described below. Furthermore, the communication apparatuses such as the AP 100 may provide network storage functions such as Network Attached Storage (NAS). Such functions are provided to other communication apparatuses as web services such as network storage services. For example, the communication apparatuses such as the STAs connect to the network storage service provided by the AP 100 using protocols such as an SMB, FTP, or WebDAV. The communication apparatuses such as the STAs upload files to the storage service or download files from the storage. Data communication for such uploading and downloading is also realized by communicating UHR PPDUs between devices.

The input unit 204 receives various operations from the user. The output unit 205 provides various outputs to the user. Here, the outputs by the output unit 205 include at least one of display on a screen, audio output by a speaker, and vibration output. The input unit 204 and the output unit 205 may be implemented as a single module, such as a touch panel.

The output unit 205 functions as a display unit for presenting information to the user. The input unit functions as a reception unit for receiving user operations.

The communication unit 206 controls wireless communication in accordance with the IEEE 802.11 standard series and controls IP communication. The communication unit 206, in cooperation with the antenna 207, can perform communication control for transmitting and receiving UHR PPDUs, which are wireless frames of the UHR standard, as well as PPDUs corresponding to earlier standards. The antenna 207 is an antenna capable of transmitting and receiving signals in at least one of the frequency bands, a sub-GHz band, 2.4 GHz band, 5 GHz band, 6 GHz band, and millimeter-wave band, for example.

If the communication apparatus supports the aforementioned NFC standard, Bluetooth® standard, or wired communication standards, the communication unit 206 may be configured to control wireless or wired communication in accordance with these standards.

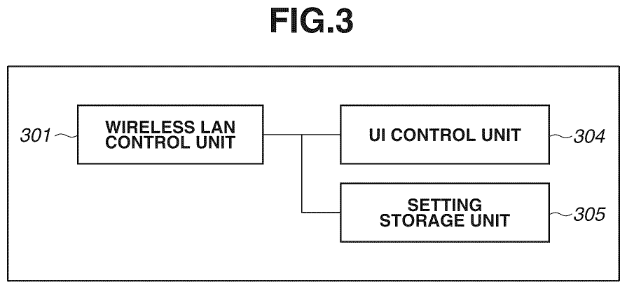

Next, the functional configuration of the AP 100 and the STAs 101 to 103 will be described with reference to FIG. 3. The communication apparatuses such as the AP 100 and the STAs 101 to 103 include a wireless LAN control unit 301, a UI control unit 304, and a setting storage unit 305.

The wireless LAN control unit 301, in cooperation with the communication unit 206 and the antenna 207, controls the transmission and reception of wireless signals to and from other wireless LAN apparatuses. The wireless LAN control unit 301 has a function of generating and transmitting frames in accordance with the IEEE 802.11 standard series, and a function of analyzing and processing frames received via the communication unit 206. That is, the control unit 301 has functions for performing reception control and transmission control of frames.

The UI control unit 304 controls the input unit 204 and the output unit 205 to present information to the user and to receive input operations from the user. The UI control unit 304 of the AP 100 displays a setting screen (not shown) and accepts operations for changing the operation setting regarding whether to use the long-distance communication mode. The settings corresponding to changes made via the setting screen are stored in the setting storage unit 305. The setting storage unit 305 stores operation settings regarding whether to use the long-distance communication mode and various setting parameters for communication. The setting storage unit 305 also stores information indicating the maximum transmission output power, a table for deriving the number of tones to be used based on power deficit (described below), and arrangement information for specifying the arrangement of the tones to be used for communication in an sRU (described below). The information indicating the maximum transmission output power is an example of a predetermined threshold.

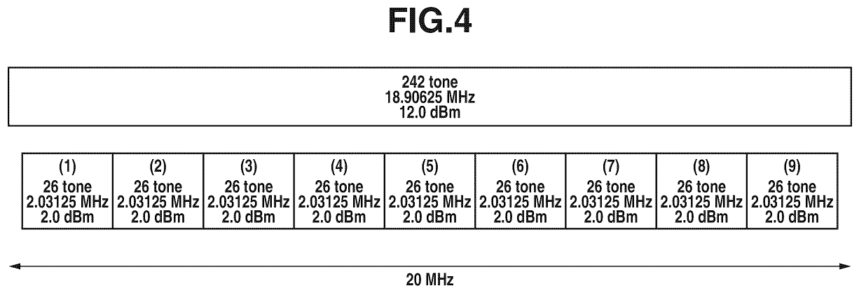

Next, the relationship between RUs and tones in MU communication in the OFDMA format will be described with reference to FIG. 4. FIG. 4 is a schematic diagram illustrating the relationship between RUs and tones.

In IEEE 802.11ax/be/bn, subcarriers for OFDMA communication are called tones. In the present embodiment, it is assumed that the frequency bandwidth of one tone is 78.125 kHz, but the present disclosure is not limited thereto. An RU is a set of consecutive tones, and the minimum resource unit in OFDMA communication is 26 tones. When allocating the minimum resource unit of 26 tones in a 20 MHz bandwidth channel, resources of 26 tones can be allocated to nine STAs, and MU communication in the OFDMA format can be performed with up to nine STAs. When allocating the equivalent of a 20 MHz bandwidth channel to one STA for OFDMA communication, resources of 242 tones can be allocated to one STA. Although two sizes of RUs are illustrated in FIG. 4, the number of tones per RU can be, for example, 26, 52, 106, 242, 484, 996, or 996×2 tones within the communication frequency bandwidth. The AP 100 determines which size of RU should be allocated to which STA based on the buffer status of the STA received from the STA, and triggers uplink MU communication.

Next, the regulations on transmission power density and the resulting maximum transmission output power will be described with examples. As an example, in Federal Communications Commission (FCC) certification in the United States, for client devices with a transmitter output of 250 mW or less, it is stipulated that the transmission power density in the 6 GHz band should be −1 dBm/MHz. Client devices with a transmitter output of 250 mW or less specifically refer to Low Power Indoor (LPI) client devices. A value of −1 dBm is an example of a predetermined transmission power density, and a value of 1 MHz is an example of a predetermined frequency bandwidth. Hereinafter, in the present embodiment, the regulation on transmission power density for LPI class client devices under FCC certification is described as an example of the transmission power density regulation.

This means that, when the communication frequency bandwidth is 20 MHz and one RU is 242 tones, a transmission output of 12 dBm/20 MHz is possible. As illustrated in FIG. 4, if one RU is 26 tones, nine RUs can be arranged within a 20 MHz bandwidth, but the upper limit of transmission power per RU is 2 dBm/2 MHz, as determined by the transmission power density regulation. Therefore, the maximum transmission output power of an STA allocated a 26-tone RU needs to be limited to 2 dBm/2 MHz.

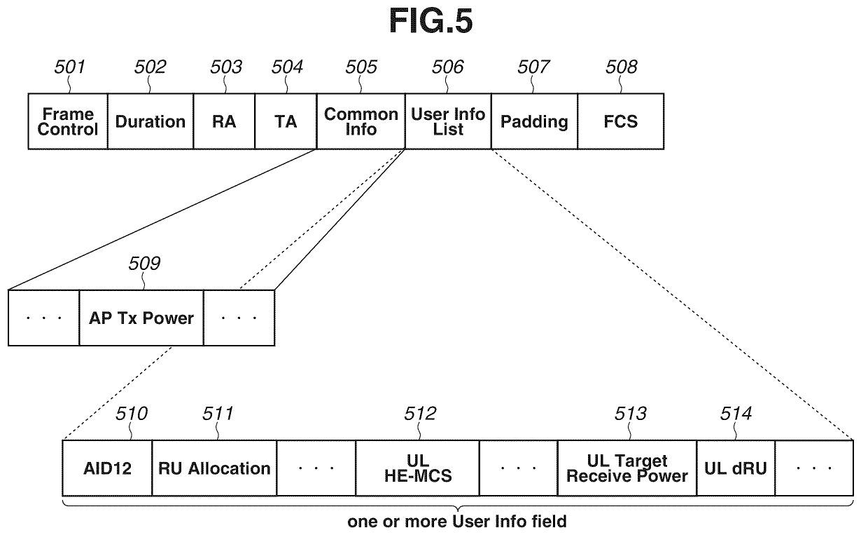

Next, transmission power control for an STA performing uplink MU communication in OFDMA will be described. Uplink MU communication in OFDMA is initiated in response to transmission of a trigger frame that triggers the uplink communication from the AP 100. At this time, the STA determines the transmission output power, the RU to be used, the transmission time, and so on, based on information in the trigger frame transmitted from the AP. FIG. 5 is a diagram illustrating an example of a format of a trigger frame transmitted by the AP 100. The fields/subfields shown here conform to the format defined in IEEE 802.11ax. In other words, the frame includes, from the beginning, a Frame Control field 501, a Duration field 502, an RA field 503, a TA field 504, a Common Info field 505, a User Info List field 506, a Padding field 507, and an FCS field 508.

The Frame Control field 501 includes a Type subfield indicating the frame type and a Subtype subfield. In the present embodiment, the Type subfield is set to “01” representing a control frame, and the Subtype subfield is set to “0010” representing a trigger. In other words, in the present embodiment, it is assumed that the AP 100 transmits a basic type trigger frame. However, the present disclosure is not limited thereto. As long as the AP, such as the AP 100, allocates one or more RUs to one or more STAs and triggers MU communication from the STA to another communication apparatus, other types of trigger frames may be used.

The Duration field 502, the RA field 503, and the TA field 504 conform to the contents of the Media Access Control (MAC) header of the trigger frame, which is a control frame defined in the IEEE 802.11ax standard.

The Common Info field 505 is a field in which common information and communication parameters for STAs participating in MU communication are stored, and includes an AP Tx Power subfield 509. This subfield includes the transmission signal strength with which the AP 100 transmits the trigger frame illustrated in FIG. 5. In addition, the Common Info field 505 includes an UP Link Length subfield indicating the duration of uplink communication and a UL BW subfield indicating the bandwidth of uplink communication. Furthermore, the Common Info field 505 includes a Spatial Reuse subfield indicating whether spatial reuse is permitted and information on the power index for spatial reuse.

Next, the User Info List field 506 is a field in which one or more User Info fields storing communication parameters for each STA participating in MU communication are stored. The AP 100 includes, in the List field 506, a number of User Info fields corresponding to the number of STAs participating in MU communication.

Further description is provided regarding the User Info field directed to each STA. An AID12 subfield 510 provides information for identifying which STA the information is directed to. The AP 100 stores, in the AID12 subfield, the Association Identifier (AID) of the STA to communicate with. In a case where random uplink access using the corresponding RU is permitted by the Uplink OFDMA Random Access (UORA) technology, a value of 0 or 2045 is stored in this subfield. On the other hand, in a case where the AP 100 allocates an RU to an individual STA, the AID issued by the AP 100 to the STA upon association is stored in this subfield.

The subsequent RU Allocation subfield 511 stores information indicating the allocation of RUs to be used when the STA simultaneously transmits data frames by OFDMA.

The STA that has received the trigger frame identifies the RU to be used by the STA itself based on the value of the RU Allocation subfield assigned to its AID and the value of the UL BW subfield in the Common Info field. Identifying the RU means identifying the frequency resource permitted for uplink transmission. In other words, the RU is an example of a frequency resource to be used by the STA. The value of the RU Allocation subfield and the value of the UL BW subfield in the Common Info field are examples of information regarding resource allocation.

A UL HE-MCS subfield 512 stores the Modulation and Coding Scheme (MCS) to be used by the STA identified by the AID. A UL Target Receive Power subfield stores information indicating the received signal strength expected to be received at the AP 100. A UL dRU subfield 514 is a subfield that stores information indicating whether to allow tone allocation such as by the dRU. Details of dRU are described below. In a case where the operation setting to use the long-distance communication mode is set, the AP 100 sets 1 in this subfield, and, in a case where the operation setting not to use the long-distance communication mode is set, the AP 100 sets 0 in this subfield. The information indicated in this subfield functions as information indicating whether a transmission method is permitted in which transmission power is adjusted by using only some tones of the RU (frequency resource) allocated to the STA and not using the other tones of the RU. When the AP 100 sets 1 in the UL dRU subfield 514, the AP 100 controls the Spatial Reuse subfield to store a value that prohibits spatial reuse. By this control, when communication with increased power density of some tones may occur, it is possible to suppress spatial reuse communication in an Overlapping Basic Service Sets (OBSS) network.

The STAs 101 to 103 that have received the trigger frame perform processing to determine whether there is an RU the STAs 101 to 103 are permitted to use. If the STAs 101 to 103 determine that there is an RU permitted for use, the STAs 101 to 103 perform processing to derive the transmission output power to be used when performing transmission using the RU.

This derivation is performed based on equation (1):

$${Tx}_{pwr}^{STA} = {PL}_{DL} + {TargetRx}_{pwr} \qquad ( 1 )$$

The DL pathloss is calculated based on equation (2):

$${PL}_{DL} = {Tx}_{pwr}^{AP} - {Rx}_{pwr} \qquad ( 2 )$$

where

$${Tx}_{pwr}^{AP}$$

is the AP's transmit power, as indicated by the AP Tx Power subfield
RX_{pwr} is the receive signal power, at the STA of the Triggering PPDU

In other words, the STA obtains the DL pathloss, which is the spatial propagation loss, based on the transmission power of the trigger frame, which is included in the trigger frame, and the received power when the trigger frame is actually received. Then, by adding the spatial propagation loss to the power expected to be received at the AP, the transmission output power to be used for transmission is derived.

In conventional standards such as IEEE 802.11ax/be, when the derived transmission output power exceeds the maximum transmit power based on radio regulations such as those of the FCC, and also exceeds the maximum transmit power stored in the STA, it is stipulated that transmission shall be performed at the maximum transmit power. However, with such a simplified control, the received power at the AP may not be sufficient, possibly resulting in packet errors. In view of this, when 1 is set in the UL dRU subfield 514, the STA performs tone allocation control by adjusting transmission power using only some tones of the frequency resource and not using the other tones of the frequency resource.

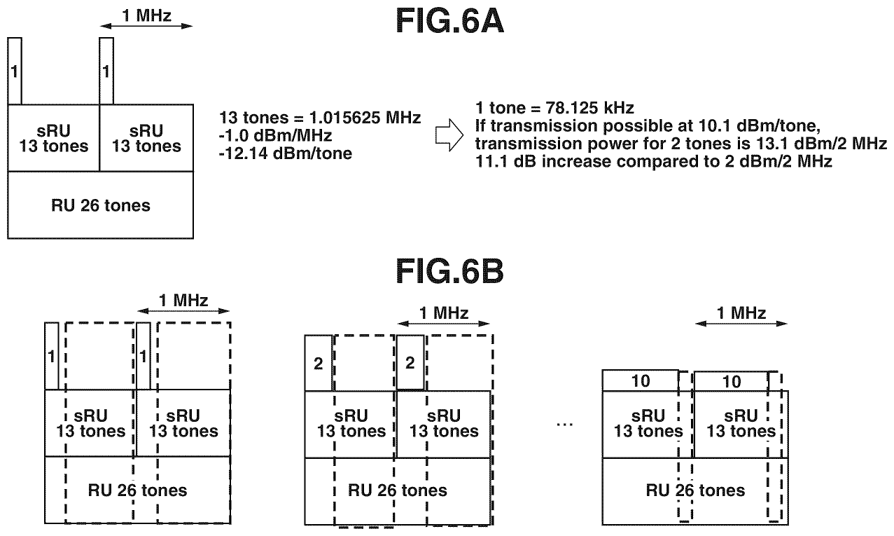

The specific mechanism is described using a schematic diagram illustrated in FIG. 6. FIG. 6 is a schematic diagram illustrating that, by further subdividing the RU and performing control to increase the transmission power of subcarriers of some tones while not transmitting signals on the other tones, the average power density of the entire RU can be kept within the maximum transmission output power. Up to and including the IEEE 802.11be standard, the minimum unit of RU is 26 tones, but in the present embodiment, the tones used for communication are distributed so that some tones in the RU are used and the other tones in the RU are not used. Specifically, an sRU (sub-RU) further subdivided into 13 tones is provided, and the tones used for communication are distributed within the sRU. When one RU includes 26 tones, there are two sRUs; when one RU includes 52 tones, there are four sRUs; when one RU includes 106 tones, there are eight sRUs; when one RU includes 242 tones, there are 18 sRUs; and when one RU includes 996 tones, there are 76 sRUs.

In the present embodiment, the frequency bandwidth of one tone is assumed to be 78.125 kHz, and in this case, the bandwidth of a 13-tone sRU is 1.015625 MHz. Therefore, if the maximum transmission power density is specified as −1 dBm/MHz, when all the 13 tones of the sRU are used for transmission, −1 dBm/MHz is the maximum permitted transmission output power.

In FIG. 6A, an example is illustrated in which only one tone in the sRU is used for communication and the other 12 tones are not used. In the present embodiment, as illustrated in FIG. 6, the transmission power of one-tone subcarrier is determined so that, when converted to the average power per 1 MHz, it becomes-1 dBm/MHz. Specifically, the STA determines to transmit at 10.1 dBm/1 tone.

When the RU allocated to the STA is 26 tones, the STA can allocate one tone to each sRU and can transmit two tones. In this case, the maximum transmission output power per tone can be 10.1 dBm as described above.

In this case, compared to the conventional maximum transmission output power of 2 dBm/2 MHz when the entire RU is used for communication, transmission can be performed at a transmission output power higher by 11 dB. Therefore, the communication range with the counterpart device can be expanded. For example, the STA 103, which is outside the area 104 where good communication is possible as illustrated in FIG. 1, can perform uplink MU communication, albeit with a narrow bandwidth, by using this technology.

In this way, by increasing the transmission power of some tones and not using the other tones, it is possible to expand the communication range while satisfying the regulation on the maximum transmission output power for a predetermined frequency bandwidth. Note that, since the frequency bandwidth available for data transmission becomes narrower, the communication capacity may decrease. This relationship is explained using Table 1.

Table 1 shows, for each number of tones, the transmission power averaged over a predetermined bandwidth including both used and unused tones, such that the average transmission power density is −1 dBm/MHz. The setting storage unit 305 of the STA also stores, as a table for deriving the number of tones to be used based on power deficit, a table exemplified in Table 2.

TABLE 1

| Number of tones | Bandwidth [kHz] | Permissible power [dBm] |
|---|---|---|
| 1 | 78.125 | 10.1 |
| 2 | 156.25 | 7.1 |
| 3 | 234.375 | 5.3 |
| 4 | 312.5 | 4.1 |
| 5 | 390.625 | 3.1 |
| 6 | 468.75 | 2.3 |
| 7 | 546.875 | 1.6 |
| 8 | 625 | 1.0 |
| 9 | 703.125 | 0.5 |
| 10 | 781.25 | 0.1 |
| 11 | 859.375 | −0.3 |
| 12 | 937.5 | −0.7 |
| 13 | 1015.63 | −1.0 |

TABLE 2

| Power deficit [dB] | Number of tones |
|---|---|
| 11 | 1 |
| 10 | 1 |
| 9 | 1 |
| 8 | 2 |
| 7 | 2 |
| 6 | 3 |
| 5 | 4 |
| 4 | 5 |
| 3 | 6 |
| 2 | 8 |
| 1 | 10 |

The STAs 101 to 104, taking into account the table shown in Table 2 and the transmission power required for communication with the AP, perform readjustment of the transmission power and the number of tones to be used. At this time, the STAs 101 to 104 perform readjustment so that, within the range of transmission power that allows good communication with the AP, the largest possible number of tones is selected. Specifically, if the transmission power to be used for transmission derived using equation (1) exceeds the maximum transmission output power of the STA, the STA obtains the difference between the derived transmission power and the maximum transmission output power. This difference is the amount of power insufficient for good communication, hereinafter referred to as “power deficit.” Then, the STAs 101 to 103 search the table stored in the setting storage unit 305, exemplified in Table 2, using the power deficit as the primary key, and determine the number of tones to be used for communication. Next, the STAs 101 to 103 transmit to the AP 100 a Trigger-based (TB) Physical layer Protocol Data Unit (PPDU) containing data stored in the RU to be used by the STAs 101 to 103. The TB PPDU is assumed to be a UHR TB PPDU, but is not limited thereto.

At this time, the STAs 101 to 103 superimpose data on the subcarrier signals corresponding to the tones determined to be used for communication, and perform transmission control so that subcarrier signals are not transmitted on the other tones. Also, the STAs 101 to 103 control the transmission power so that the output signal strength of the subcarrier signals corresponding to the tones determined to be used for communication matches the determined transmission power.

Note that the table in Table 2 shows the number of tones set for the 13-tone sRU described above. For example, if the power deficit is 11 dB, the STA uses only one tone in the sRU and does not use the other 12 tones for transmission. In this case, transmission control is performed so that the transmission power is increased by the power deficit of 11 dB. For example, if the power deficit is 1 dB, the STA uses 10 tones in the sRU and does not use 3 tones for transmission. In this case, transmission control is performed so that the transmission power is increased by the power deficit of 1 dB.

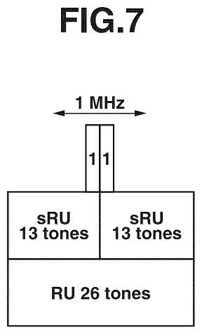

Next, the arrangement of tones to be used for transmission within the sRU will be described with reference to FIGS. 6B and 7. FIG. 7 is a schematic diagram illustrating a comparative example of tone arrangements. In FIG. 7, an example is shown in which the tone at the end of sRU1 and the tone at the end of the adjacent sRU2 are used for transmission. If tones to be used for communication are arranged in adjacent regions in this way, two tones are arranged within a 1 MHz equivalent bandwidth. If such a tone arrangement is adopted and transmission power control is performed so that the transmission power of the two tones is increased by 11 dB, the average transmission power density in the 1 MHz equivalent frequency bandwidth shown in FIG. 7 will exceed the specified value of −1 dBm/MHz.

In view of this, in the present embodiment, the arrangement of the tones to be used is set according to the number of tones to be used so that transmission can be performed within the prescribed transmission power density. Table 3 shows the number of tones to be used and their arrangement. Table 3 is an example of arrangement information for specifying the arrangement of tones.

TABLE 3

| Tone(s) used for communication | Tone spacing with adjacent RU |
|---|---|
| (out of 13 tones) | (Frequency spacing) |
| 1 | 12 (937.5 kHz) |
| 2 | 11 (859.375 kHz) |
| 3 | 10 (781.25 kHz) |
| 4 | 9 (703.125 kHz) |
| 5 | 8 (625 kHz) |
| 6 | 7 (546.875 kHz) |
| 8 | 5 (390.625 kHz) |
| 10 | 3 (234.375 kHz) |

Each STA, based on the arrangement information exemplified in Table 3, arranges the tones to be used continuously from the left end of the sRU and controls the transmission power to compensate for the power deficit as exemplified in Table 2. This is described with reference to FIG. 6B. In a case where only one tone is to be used, the STA uses the subcarrier signal of the leftmost tone for data communication, while controlling so that subcarrier signals are not transmitted on the other 12 tones between the adjacent sRUs indicated by the dashed line. In a case where two tones are to be used, the STA uses the subcarrier signals of the leftmost two tones for data communication, while controlling so that subcarrier signals are not transmitted on the other 10 tones between the adjacent sRUs indicated by the dashed line. In a case where ten tones are to be used, the STA uses the subcarrier signals of the leftmost ten tones for data communication, while controlling so that subcarrier signals are not transmitted on the other three tones between the adjacent sRUs indicated by the dashed line.

In this way, in the present embodiment, the arrangement of tones to be used for communication is set in consideration of the fact that there may be tones used for data communication in adjacent sRUs. By adopting this arrangement method, even if the average power density of any 1 MHz bandwidth within the RU used by one STA for communication is measured, the average power density of any 1 MHz bandwidth does not exceed the specified value. In this way, the allocation, within the RU, in which the spacing between tones to be used for communication is widened so that the average power density of the 1 MHz bandwidth is the specified value or less is called distributed RU (dRU). Uplink communication using this dRU is called uplink communication using the dRU. Note that the method of arranging tones for communication from the left end is just one example, and the arrangement method is not limited thereto.

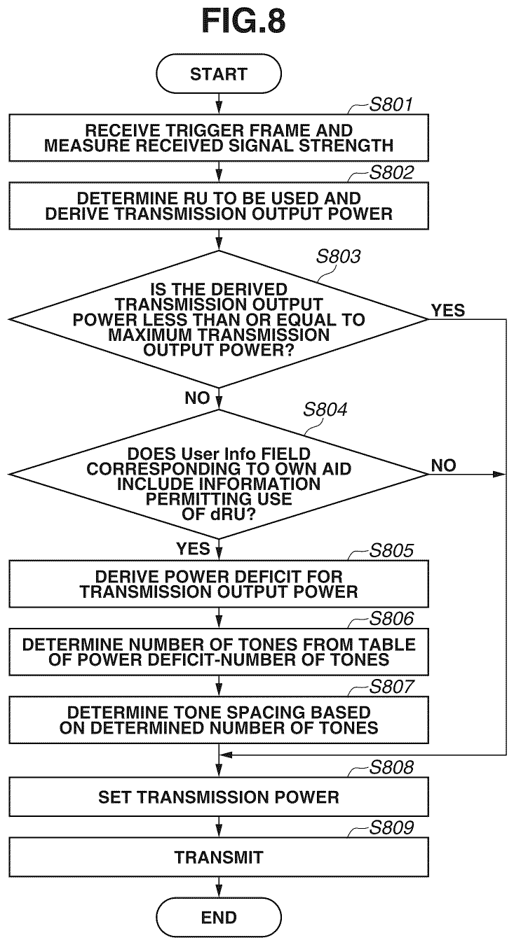

The control of uplink communication using the dRU in the STA will be described with reference to FIG. 8. FIG. 8 is a flowchart illustrating an example of control executed in the STAs 101 to 103 or the like. FIG. 8 extracts control related to uplink MU communication in the OFDMA scheme performed in response to reception of a trigger frame transmitted from the AP 100. The processing steps shown in the flowchart of FIG. 8 are executed by the processor of the control unit 202 of the STAs 101 to 103 executing a computer program stored in the storage unit 201. Some processing, such as transmission and modulation, is realized by cooperation between the processor of the control unit 202 and various processors, ASICs, DSPs, FPGAs included in the communication unit 206, and ASICs, DSPs, FPGAs included in the control unit 202. If it is desired to clearly indicate the subject of processing, the functional unit described in FIG. 3 is used as the subject.

In step S801, the wireless LAN control unit 301, in cooperation with the antenna 207 and the communication unit 206, receives the trigger frame transmitted by the AP 100 and measures the received signal strength of the trigger frame.

Next, in step S802, the wireless LAN control unit 301 determines the RU, which is the frequency resource to be used by itself, based on the trigger frame, and derives the transmission output power assuming that the determined RU is used for uplink communication.

Specifically, the wireless LAN control unit 301 analyzes the AID12 subfield in the User Info List field of the trigger frame and determines whether a User Info field containing an AID corresponding to the wireless LAN control unit 301 is included in the trigger frame. If a User Info field containing the AID corresponding to the control unit 301 is included, the wireless LAN control unit 301 obtains the value of the RU Allocation subfield contained in the User Info field. Next, based on the value of the RU Allocation subfield and the value of the UL BW subfield in the Common Info field, the wireless LAN control unit 301 identifies the RU to be used by the wireless LAN control unit 301 itself. Then, the wireless LAN control unit 301 obtains a value 1 of the UL Target Receive Power subfield in the User Info field containing the AID of the wireless LAN control unit 301. The wireless LAN control unit 301 also obtains a value 2 of the AP Tx Power subfield in the Common Info field. The wireless LAN control unit 301 substitutes the obtained value 2 and the received signal strength measured in step S801 into equation (2) to derive the DL pathloss. Then, the wireless LAN control unit 301 substitutes the derived DL pathloss and the obtained value 1 into equation (1) to derive the transmission output power assuming that the determined RU is used for uplink communication. In the present embodiment, the case where an RU is allocated to the STA's AID for scheduled transmission is exemplified, but the present disclosure is not limited to this. The present embodiment can also be applied when using the UORA function, which is an uplink random access technology. In this case, the STA identifies the number of random RUs in which 0 or 2045 is stored in the AID12 subfield. Then, based on the identified number of RUs, the wireless LAN control unit 301 determines whether it can succeed in random access contention by decrementing the OFDMA backoff (OBO) counter for uplink contention. If the wireless LAN control unit 301 determines that it can succeed in random access contention, the wireless LAN control unit 301 derives the transmission output power. If an RU is not allocated for the wireless LAN control unit 301 and the STA does not succeed in the random access contention based on the OBO counter, the wireless LAN control unit 301 determines not to participate in MU transmission based on the trigger frame and ends the series of processing.

In step S803, the wireless LAN control unit 301 determines whether the transmission output power derived in step S802 is less than or equal to the value representing the maximum transmission output power stored in the setting storage unit 305 (predetermined threshold). If the wireless LAN control unit 301 determines that the transmission output power derived in step S802 is less than or equal to the value representing the maximum transmission output power, the processing proceeds to step S808. On the other hand, if it determines that the transmission output power derived in step S802 exceeds the value representing the maximum transmission output power, the processing proceeds to step S804.

In step S804, the wireless LAN control unit 301 determines whether information permitting the use of dRU is included in the User Info field corresponding to the AID of the wireless LAN control unit 301. Specifically, the wireless LAN control unit 301 obtains the value of the UL dRU subfield 514 in the received trigger frame. If the value is set to 1, the wireless LAN control unit 301 determines that information permitting the use of dRU is included; if the value is set to 0, the wireless LAN control unit 301 determines that the information permitting the use of dRU is not included. If the wireless LAN control unit 301 determines that information permitting the use of dRU is included, the processing proceeds to step S805; if the information permitting the use of dRU is not included, the processing proceeds to step S808.

In step S805, the wireless LAN control unit 301 derives the difference between the maximum transmission output power stored in the setting storage unit 305 and the transmission output power derived in step S802, and stores this difference as the power deficit.

Next, in step S806, the wireless LAN control unit 301 searches the table (the table exemplified in Table 2) stored in the setting storage unit 305 using the power deficit as the primary key, and determines the number of tones to be used for communication.

In step S807, the wireless LAN control unit 301 determines the tone arrangement of the dRU based on the number of tones determined in step S806 and the arrangement information exemplified in Table 3. Then, in step S808, the wireless LAN control unit 301 sets the transmission conditions so that data is transmitted with the transmission output power considering the power deficit and with the determined tone arrangement.

Note that, if the determination in step S803 is Yes, the wireless LAN control unit 301 sets the transmission conditions so that data is transmitted at the transmission output power derived in step S802 and using the entire RU determined in step S802. If the determination in step S804 is No, the wireless LAN control unit 301 sets the transmission conditions so that data is transmitted at the maximum transmission power and using the entire RU determined in step S802.

In step S809, the wireless LAN control unit 301, in cooperation with the communication unit 206 and the antenna 207, controls transmission of the UHR TB PPDU under the transmission conditions set in step S807. When using the dRU, the STA controls transmission so that the UHR TB PPDU, in which data is superimposed on the subcarriers of the tones (tones to be used for uplink communication) determined in the above-described processing, is transmitted at the determined output signal strength. The UHR TB PPDU is transmitted to the AP, which is the transmission source of the trigger frame. At this time, the STA controls transmission so that subcarrier signals are not transmitted on the other tones in the RU that are different from the tones to be used for uplink communication. The wireless LAN control unit 301 transmits the UHR TB PPDU after the lapse of Short Inter Frame Space (SIFS) time from the completion of reception of the trigger frame.

By the above-described control, the tones to be used for data communication can be divided into finer frequency units than the RU, and the tones actually used for data communication can be distributed within the fine frequency units. This control makes it possible to increase the actual data transmission output power while complying with the regulation on the upper limit of average power density per 1 MHz, thereby extending the communication distance. Furthermore, it is possible to set and transmit using an MCS that achieves a high transmission rate while extending the communication distance.

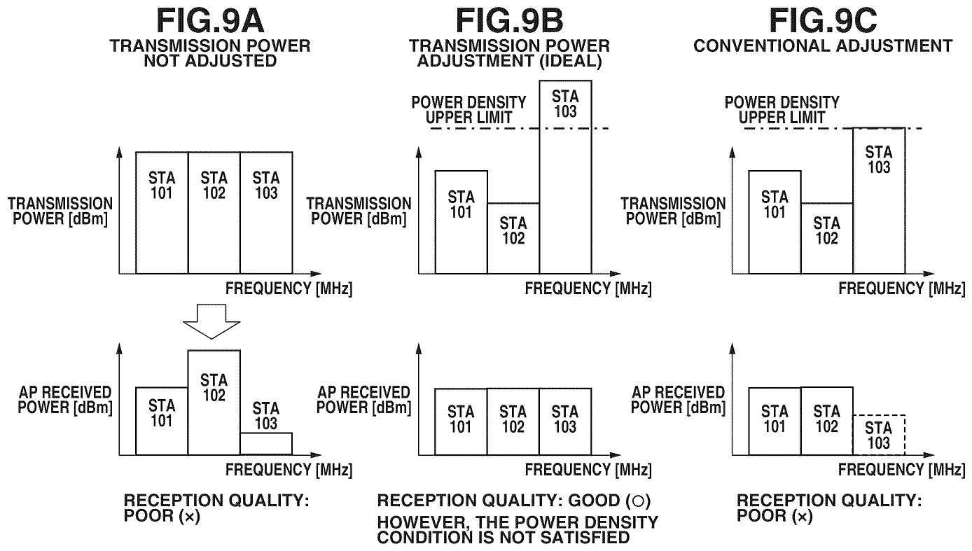

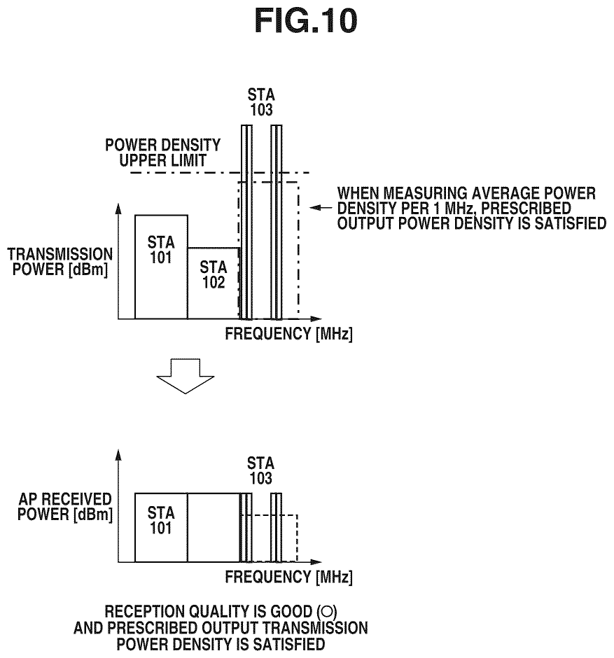

Finally, the effects of the series of controls described in this embodiment will be described with reference to the comparative examples in FIG. 9 and FIG. 10. FIGS. 9 and 10 illustrate, for the positional relationships of the STAs shown in FIG. 1, the transmission output power of each STA and the received signal power at the AP 100 when uplink MU communication in the OFDMA scheme is performed.

FIG. 9A is an example of reception when transmission power is not adjusted; FIG. 9B is an example of reception when transmission power adjustment is performed without considering the output limit; and FIG. 9C is an example of reception when conventional transmission power control is performed. FIG. 10 shows an example of reception when transmission power adjustment using the dRU proposed in this embodiment is performed.

FIG. 9A is an example in which the STAs with the positional relationships illustrated in FIG. 1 perform data transmission using a common transmission output power. The signals transmitted by each STA are delivered to the AP via transmission paths with different propagation environments. Therefore, the received signal power at the AP from each STA differs. In this case, the AP 100 operates to lower the gain of the receiving circuit so that the receiving circuit does not saturate due to the received power from the STA 102. Lowering the gain of the receiving circuit based on the signal transmitted from the STA 102 causes a decrease in the received signal power and received signal quality (SNR: Signal to Noise Ratio) for the signal transmitted from the STA 103, which has the lowest received power.

FIG. 9B shows an example in which power adjustment control based on equations (1) and (2) is simply performed. By performing such adjustment, the received signal power received from each STA at the AP can be made uniform. However, there is an issue that the regulation on power density is not satisfied. FIG. 9C is an example of the conventional method in which, when the transmission power to be used for transmission exceeds the maximum transmission output power due to power adjustment control, transmission is performed at the maximum transmission power. In this example, the AP 100 can properly receive signals from the STA 101 and STA 102, but the received signal power from STA 103 becomes low, which may cause issues in reception quality.

Lastly, FIG. 10 shows an example of a case where the method according to the present embodiment is applied. FIG. 10 illustrates the case where the STA 103, which determines that the transmission power derived based on equations (1) and (2) exceeds the maximum transmission output power, performs uplink communication using the dRU. By using the dRU, the STA 103 performs processing to boost the transmission power used for data transmission. In this processing, as described above, power adjustment and tone arrangement are performed so that the regulation on the average power density of the specified frequency band is satisfied. In this case, the received signal power from the STAs 101 to 103 at the AP 100 becomes uniform, so the aforementioned decrease in SNR is also suppressed. As a result, communication with good reception quality can be performed. Furthermore, since the decrease in SNR is suppressed, the STA 103 can also communicate using an MCS with a higher transmission rate.

### Modified Example

In the first embodiment, it was assumed that the table shown in Table 2 is used to derive the number of tones from the power deficit, but the present disclosure is not limited to this. For example, it is also possible to configure the system to use different tables depending on the value stored in the UL Target Receive Power subfield. The advantage of this is described as follows. When the received signal strength level at the AP 100 is set relatively high, error correction technology may be able to cover transmission errors caused by some decrease in received power. In view of this, in the modified example, the table to be used is changed depending on whether the value of UL Target Receive Power is −70 dBm or higher. In this case, if it is not −70 dBm or higher, the number of tones is derived using the table shown in Table 2, and if it is −70 dBm or higher, the number of tones is set as shown in Table 4. In this case, if the power deficit is less than 5 dBm, the STA may perform data communication using all 13 tones.

TABLE 4

| Power Deficit [dBm] | Number of Tones |
|---|---|
| 11 | 1 |
| 10 | 1 |
| 9 | 1 |
| 8 | 2 |
| 7 | 2 |
| 6 | 3 |
| 5 | 4 |
| 4 or less | 13 |

In addition, in the present embodiment, the case where data is superimposed on each tone determined to be used for uplink communication was exemplified, but the present disclosure is not limited to this. It is also possible to use some of the tones determined to be used for uplink communication as pilot signals without superimposing data. In this case, although the data transmission capacity decreases, the number of pilot signals serving as references for reception can be increased, thereby improving reception quality at the AP.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The disclosure is not limited to the above embodiments, and various changes and modifications can be made without departing from the spirit and scope of the disclosure. Therefore, claims are attached to publicly disclose the scope of the disclosure.

According to one aspect of the present disclosure, it becomes possible to receive data from an STA located far from the AP while satisfying the regulation of maximum transmission power density. As a result, the communication range in which the STA can communicate with the AP can be expanded.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
at least one memory that stores a set of instructions; and
at least one processor that executes the instructions, the instructions, when executed, causing the communication apparatus to perform operations comprising:
performing a reception control to receive a trigger frame;
determining, based at least on a received signal strength of the trigger frame received by the communication apparatus, information indicating transmission power included in the trigger frame, and a frequency resource permitted to be used by the communication apparatus for uplink transmission which has been identified based on information regarding resource allocation included in the trigger frame, tones to be used for uplink communication in the frequency resource and an output signal strength of subcarrier signals in the tones; and
performing a transmission control to transmit, at the determined output signal strength, a Trigger-based (TB) Physical layer Protocol Data Unit (PPDU) in which data is superimposed on subcarriers corresponding to the tones determined as tones to be used;
wherein, in the determining, the tones to be used for uplink communication and the transmission output power are determined so that a transmission power density for the frequency resource as a whole is within a predetermined transmission power density specified for each predetermined frequency bandwidth, and
in performing the transmission control, transmission is controlled so that subcarrier signals are not transmitted on other tones included in the frequency resource that are different from the tones to be used for uplink communication.

2. The communication apparatus according to claim 1, wherein the trigger frame includes information indicating an Association Identifier (AID) of the communication apparatus, and, as information associated with the AID, information indicating the frequency resource permitted to be used by the communication apparatus identified by the AID for uplink transmission.

3. The communication apparatus according to claim 2, wherein the trigger frame further includes, as information associated with the AID, information indicating whether a transmission method is permitted in which transmission power is adjusted by using some tones of the frequency resource and not using the other tones.

4. The communication apparatus according to claim 2,
wherein the trigger frame includes, as information associated with the AID, information indicating the received signal strength expected to be received at a source communication apparatus that has transmitted the trigger frame, and
in the determining, the tones to be used and the output signal strength of subcarrier signals in the tones are determined based on the received signal strength of the trigger frame, information indicating transmission power included in the trigger frame, and information indicating the expected received signal strength at the source communication apparatus.

5. The communication apparatus according to claim 4,
wherein the operations further comprise:
determining, based on the received signal strength of the trigger frame, information indicating transmission power included in the trigger frame, and information indicating the received signal strength expected to be received at the source communication apparatus, a transmission output power assuming that all subcarriers corresponding to the frequency resource are used for uplink communication; and
in a case where the frequency resource is 26 tones and the determined transmission output power exceeds a predetermined threshold, determining that tones fewer than 26 tones are to be used for uplink communication.

6. The communication apparatus according to claim 5,
wherein, in a case where it is determined that tones fewer than 26 tones are to be used for uplink communication, the tones fewer than 26 tones are arranged within the frequency resource based on information specifying an arrangement stored in the communication apparatus.

7. The communication apparatus according to claim 1,
wherein the minimum number of tones to be used for uplink communication determined in the determining is two tones.

8. The communication apparatus according to claim 1, wherein the communication apparatus is an Internet of Things (IoT) device.

9. A control method for a communication apparatus, comprising:
performing a reception control to receive a trigger frame;
determining, based at least on a received signal strength of the trigger frame received by the communication apparatus, information indicating transmission power included in the trigger frame, and a frequency resource permitted to be used by the communication apparatus for uplink transmission which has been identified based on information regarding resource allocation included in the trigger frame, tones to be used for uplink communication in the frequency resource and an output signal strength of subcarrier signals in the tones; and
performing a transmission control to transmit, at the determined output signal strength, a Trigger-based (TB) Physical layer Protocol Data Unit (PPDU) in which data is superimposed on subcarriers corresponding to the tones determined as tones to be used;
wherein, in the determining, the tones to be used for uplink communication and the transmission output power are determined so that a transmission power density for the frequency resource as a whole is within a predetermined transmission power density specified for each predetermined frequency bandwidth, and
in performing the transmission control, transmission is controlled so that subcarrier signals are not transmitted on other tones included in the frequency resource that are different from the tones to be used for uplink communication.

10. A non-transitory computer readable storage medium that stores a program that causes, when the program is executed, a communication apparatus to perform:
a reception control to receive a trigger frame;
determining, based at least on a received signal strength of the trigger frame received by the communication apparatus, information indicating transmission power included in the trigger frame, and a frequency resource permitted to be used by the communication apparatus for uplink transmission which has been identified based on information regarding resource allocation included in the trigger frame, tones to be used for uplink communication in the frequency resource and an output signal strength of subcarrier signals in the tones; and
a transmission control to transmit, at the determined output signal strength, a Trigger-based (TB) Physical layer Protocol Data Unit (PPDU) in which data is superimposed on subcarriers corresponding to the tones determined as tones to be used;
wherein, in the determining, the tones to be used for uplink communication and the transmission output power are determined so that a transmission power density for the frequency resource as a whole is within a predetermined transmission power density specified for each predetermined frequency bandwidth, and
in performing the transmission control, transmission is controlled so that subcarrier signals are not transmitted on other tones included in the frequency resource that are different from the tones to be used for uplink communication.
